(19) United States
(12) Patent Application Publication
(10) Pub. No.: US 2024/0370558 A1
(43) Pub. Date: Nov. 7, 2024

(54) SYSTEMS AND METHODS FOR DETECTING UNKNOWN PORTABLE EXECUTABLES MALWARE

(71) Applicant: B. G. NEGEV TECHNOLOGIES AND APPLICATIONS LTD., AT BEN-GURION UNIVERSITY, Beer-Sheva (IL)

(72) Inventors: Nir NISSIM, Ashdod (IL); Ido FINDER, Raanana (IL); Eitam SHITRIT, Haifa (IL)

(21) Appl. No.: 18/683,281

(22) PCT Filed: Aug. 31, 2022
(86) PCT No.: PCT/IL2022/050954

§ 371 Date: Feb. 13, 2024

Related U.S. Application Data
(60) Provisional application No. 63/239,553, filed on Sep. 1, 2021.

(51) Int. Cl. G06F 21/56; G06F 21/53

(52) U.S. Cl. CPC G06F 21/56; G06F 21/53

(57) ABSTRACT

Provided herein are systems and methods for detecting unknown portable executable (PE) malware utilizing dynamic analysis and temporal patterns. More specifically, the systems and methods provided herein utilize active learning. for enhanced detection of malware in the short and long term based on dynamic analysis and temporal patterns.

### TECHNICAL FIELD

The present disclosure generally relates to identification of cyber threats. More specifically, but not exclusively, to systems and methods for detecting unknown portable executable (PE) malware utilizing dynamic analysis and temporal patterns.

### BACKGROUND

Malware (malicious software) is a growing cybersecurity threat. According to McAfee Labs 2021 threat report, 125 million new malware samples (i.e., files) were discovered in the fourth quarter of 2020 compared to 60 million discovered in the first quarter of 2020. These attacks are aimed at individuals, organizations, and governments.

The ongoing development of malware has been accompanied by the development of security mechanisms aimed at malware before it causes harm. In recent years, machine learning (ML) methods that can leverage features extracted from the examined files for the accurate detection of unknown malware have been integrated in these detection mechanisms. Generally, the features can be extracted in two ways, the first, which is applied in most antivirus (AV) products (“antimalware”), is by performing static analysis, where the extraction of necessary information regarding the inspected file is done directly from the file's structure or content without executing it, however this has many limitations, especially in the detection of new and evasive malware such as code obfuscation, packing, encryption, and dynamic code loading. The second, is to perform dynamic analysis of the malware, which refers to the analysis of a program's behavior, captured during its execution, usually in an isolated environment.

Despite the benefits of behavioural-based detection of new malware made possible by dynamic analysis, similar to static analysis-based antivirus tools, the unknown malware detection capabilities of models trained on known malware repositories are still limited. One of the limitations associated with machine learning (ML) based detection models lies in their inability to keep abreast with the changing reality, and thus they are less effective and accurate in the long run, especially when it comes to new unknown malware. The inability to adjust does not just pertain to the ML or data mining (DM) algorithm used at the core of the detection model (e.g., classic ML or deep learning), it also pertains to the setup by which it is (if at all) being updated to reflect the changing reality and improve its capabilities over the long run. The changing reality includes the formation of new PE files on a daily basis, which leads to concept drift, a phenomenon in which the statistical properties of a target variable change over time in an unforeseen way. One of the most critical consequences of concept drift is its direct impact on the generalization capabilities of trained models whereby these capabilities decrease as time passes. The formation of new and complex malware on a daily basis means that the detection models, as well as the malware signature repository of the AV tools, must be frequently updated with new data. This is accompanied by the need to provide the new data samples with their ground-truth label, which, in many cases, especially in the cybersecurity domain, requires the involvement of human experts. Furthermore, the tremendous amount of new data generated daily makes it infeasible to manually label it all and use it to retrain the detection models, in terms of both the manpower and computational resources cost.

With the formation of new cyber threats, such as malware, the models used to detect those threats must be updated and trained on new instances as they are discovered. In fact, the formation of new malware results in a concept drift. In machine learning, concept drift usually refers to a phenomenon in which the statistical properties of a target variable change over time in an unforeseen way. This can be due to changes in a hidden context that cannot be measured directly. One of the most critical consequences of the concept drift is its direct impact on the generalization capabilities of trained models where these capabilities decrease as time passes.

Thus, there is a need in the art for methods and systems for efficiently detecting unknown malware of PE files in the short and long term, in order to improve cyber security in an efficient, accurate, cost and time effective manner.

### SUMMARY

According to some embodiments, there are provided systems and methods for efficient detection of unknown malware of PE files in the short and long term, and to enable frequent updates of the detection models and of the malware signature repository of AV tools with new malicious labelled PE files. Advantageously, the methods and systems disclosed herein allow increasing the detection capabilities of the detection models in the long term, as time passes, based, inter alia, on short term identification thereof.

According to some embodiments, there are provided herein systems, methods, and non-transitory computer-readable medium for detecting unknown PE malware using dynamic analysis and temporal patterns (TP)-based active learning framework.

Advantageously, the use of dynamic analysis enables the extraction of rich and time-based behavioral information regarding actions/events that took place (for example, application programming interface (API) calls), during the execution of examined files. The dynamic analysis enables the acquisition of behavioral and time-oriented information regarding the examined files, such as, portable executables (PE) files. As disclosed herein, advantageously, the use of time-based information facilitates the in-depth behavioral malware analysis, while allowing handling time-oriented data and extraction of various temporal patterns in accurate and efficient manner.

According to some embodiments, provided herein is a fully automated temporal pattern (TP) mining framework that can identify statistically significant discriminative TPs from the behaviour of portable executables' (PEs), based on their timestamped API calls. Advantageously, the use of the discriminative TPs enables to successfully differentiate between malicious and benign samples (i.e., files).

According to some embodiments, the methods and systems disclosed herein utilize, inter alia, Machine learning (ML) and Active learning (AL) frameworks whereby new and unlabeled instances/events are actively selected based on their potential to contribute to the learning process and sent for labeling (by any suitable methods, including, manual (human) labeling)) by an oracle module, before being fed into the identification/detection model for retraining.

According to some embodiments, advantageously, the use of TPs based AL framework provides temporal-based explainability for the temporal patterns regarding a PE's behavior. These patterns are informative and can be used (for example, by security experts) for educational purposes as well as to better defend against future attacks.

According to further embodiments, advantageously, the time-interval TP-based AL methods disclosed herein can be integrated in the ecosystem of existing antimalware tools to improve their ability to detect unknown malware, reduce manual labelling efforts, and ensure that the detection model is up to date as possible.

According to some embodiments, advantageously, the presented AL framework can thus both enrich the signature-based antimalware tool with new unknown malware samples and further enhance the detection model's generalization capabilities through the use of a dynamic analysis, time-interval TP mining, AL methods, and ML algorithms.

According to some embodiments, a method for detecting unknown portable executable (PE) malware is provided. The method includes the steps of:
receiving a new stream of PE files with unknown label of malicious or benign;
executing the unknown label PE files in a dynamic analysis environment;
creating application programming interface (API) call multi variate time series data (MTSD);
extracting time-interval temporal patterns (TPs) representing the PE files from said API calls MTSD;
applying on the PE files represented by the TPs a machine learning (ML) based detection model and an AL module;
receiving ML predictions labels based on f TPs from the ML based detection model; selecting a subset of PE files by the AL module;
labeling each PE file based on the dynamic analysis and identified TPs and on the ML predictions labels;
detecting malicious PE files based on the labeled subset of PE files by the AL module and/or the received ML predictions labels.

According to some embodiments, the API calls MTSD may be created by extracting API names and timestamps and arranging the API names and timestamps in a raw table.

According to some embodiments, extracting time-interval TPs includes dividing each sample's raw MTSD into sized bins, and calculating occurrence rates of the API calls that appear in each bin.

According to some embodiments, the bins may have equal time length. According to some embodiments, each bin size may be in the length of about 0.5-3 seconds. In some embodiments, the bin size may be about 1 second.

According to some embodiments, the method may further include a step of comparing the received stream of PE files with unknown label to files in an antimalware repository and filtering only the PE files with unknown label.

According to some embodiments, the method may further include the step of updating the antimalware repository with the files labeled as malicious.

According to some embodiments, the labeling may be facilitated by a human expert; or automatically.

According to some embodiments, the method may include utilizing a selection method for selecting a subset of PE files, said selection method assigns a vertical support (VS) score for each file.

According to some embodiments, the selected subset of PE files comprises PE files that have been identified to be the most informative files in accordance with the utilized selection method.

According to some embodiments, the most informative PE files are the PE files with the most frequent TPs.

According to some embodiments, the selection method may be selected from: Random, All, Marginal Ratio (MR), Malicious Score (MS), Marginal Malicious Score (MMS) or any combination thereof.

According to some embodiments, the method may further include a step of adding the labeled PE files to a training set of the ML based detection model and updating the ML based detection model and/or the VS scores of the TPs based on the labeled PE files.

According to some embodiments, the ML classifier may be selected from: Temporal Probabilistic proFile (TPF) with top-3, Random Forest (RF), Support Vector Machine (SVM), Logistic Regression (LR), or any combination thereof.

According to some embodiments, the vertical support score may be the maximum frequency of a specific TP among all of the TPs belonging to a specific class.

According to some embodiments, the dynamic analysis and temporal patterns based active learning (AL) framework may be executed on Windows 10 Operation System (OS) environment.

According to some embodiments, the dynamic analysis and temporal patterns based active learning (AL) framework, may be performed on host and guest environments and a sandbox tool which integrates between the host and guest environments. In some embodiments, the sandbox tool may be, for example, a Cuckoo Sandbox.

According to some embodiments, the method includes selecting a ML classifier and applying on the TPs the ML based detection model using said selected ML classifier.

According to some embodiments, applying on the TPs the ML based detection model and the AL module may be performed simultaneously.

According to some embodiments, the method further may further include providing an explanation regarding the prediction label and/or the detection of the malicious files.

According to some embodiments, the explanation may be based, at least in part on a trend of TPs of a PE file.

According to some embodiments there is provided a method for selecting a subset of PE files represented by time interval temporal patterns (TPs) having a vertical support (VS) value for each TP, in an active learning module. The method includes the steps of:
receiving a plurality of PE files;
calculating for each PE file a maliciousness value of each TP by an exponent to the power of a difference between the TP's VS values for a malicious class and a benign class; and
selecting the PE files with the maliciousness value which are above a predefine threshold.

According to some embodiments, the maliciousness value is calculated according to equation (formula) (3):

$$M S ( {s}_{i} ) = \frac{1}{N} {\sum }_{j = 1}^{N} {e}^{( {VS}_{M , j} - {VS}_{B , j} )} \qquad ( 3 )$$

wherein MS (sᵢ) denotes the malicious score of a PE file sᵢ;
N denotes the number of TPs identified in the PE file;
VS_{M,j} denotes the VS value of the j'th TP for the malicious class; and
VS_{B,j} denotes the VS value of the j'th TP for the benign class.

According to some embodiments, the method further comprises:
calculating a marginal ratio score MR (sᵢ) for the PE file according to equation (formula) (2):

$$M R ( {s}_{i} ) = \frac{1}{N} {Σ}_{j = 1}^{N} {1}_{LB < max \{ {VS}_{M , j} , {VS}_{B , j} \} < U B} \qquad ( 2 )$$

wherein LB denotes a lower bound of the margin and UB denotes an upper bound of the margin;
and calculating a marginal malicious score MMS (sᵢ) for the PE file according to equation (formula) (4):

$$M M S ( {s}_{i} ) = ( 1 - β ) * M R ( {s}_{i} ) + β * M S ( {s}_{i} ) \qquad ( 4 )$$

Wherein β is a coefficient that determines the weight of each method MR (sᵢ) and MS (sᵢ) in the final MMS (sᵢ) score.

According to some embodiments the β coefficient may be set to a value of between 0 and 1. In some embodiments, the β coefficient may be set to be 0.5.

According to some embodiments, there is provided a non-transitory computer-readable medium having stored thereon instructions that cause a processor to:
receive a new stream of PE files with unknown label of malicious or benign;
execute the unknown label PE files in a dynamic analysis environment;
create application programming interface (API) call multi variate time series data (MTSD);
extract time-interval temporal patterns (TPs) representing the PE files from said API calls MTSD;
apply on the PE files represented by the TPs a machine learning (ML) based detection model and an AL module;
receive ML predictions labels based on TPs from the ML based detection model;
select a subset of PE files by the AL module;
label each PE file based on the dynamic analysis and identified TPs and on the ML predictions labels;
detect malicious PE files based on the labeled subset of PE files by the AL module and/or the received ML predictions labels.

According to some embodiments, there is provided a system for detecting unknown portable executable (PE) malware. The system includes a processor executing a code configured to execute the method for detecting unknown portable executable (PE) malware, as disclosed herein above. In some embodiments, the system may further include a user interface, a display, a memory module, one or more additional processors, and the like, or any combination thereof.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIG. 1 shows a schematic block diagram of a framework for detecting unknown PE malware using dynamic analysis and temporal patterns based active learning framework, according to some embodiments;

FIG. 2 shows a schematic flowchart of a method for detecting unknown PE malware using dynamic analysis and temporal patterns utilizing active learning, according to some embodiments;

FIG. 3A schematically shows a flowchart demonstrating the use of TPs in an AL framework, according to some embodiments;

FIG. 3B schematically shows an example of a pseudocode implementing an algorithm for using the TP in an AL framework, according to some embodiments;

FIG. 4A schematically shows an example of an API call event captured in a cuckoo sandbox report, according to some embodiments;

FIG. 4B shows an example of a raw API call MTSD table, according to some embodiments;

FIG. 5 shows Table 1 which presents data collection by family or file type, according to some embodiments;

FIG. 6 schematically shows the percentage of malicious samples selected by each of the selection methods (MMS, MS, MR, ALL=samples; Random=random group) from all of the malware available in each daily stream, according to some embodiments;

FIG. 7 schematically shows the area under the curve (AUC) and false positive rate (FPR) metrics of the classification models for each of the indicated selection method, according to some embodiments;

FIG. 8 schematically shows the average performance of the four classifiers (SVM, Random forest, Top 3 and Logistic Regression) on the last day (after the model has been updated for 10 days), using different daily acquisition amounts (K), according to some embodiments;

FIGS. 9A-9B schematically show one example of a malicious trend that was identified when using the MS selection method over a 10-day period, according to some embodiments; and

FIG. 10 schematically shows MS-based ML classifier of the present disclosure compared to three traditional ML classifiers, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention. According to some embodiments, there are provide methods, framework and computer readable medium for detecting unknown PE malware using dynamic analysis and temporal patterns based active learning framework.

### DEFINITIONS

According to some embodiments, as used herein the term “portable executable” or “PE” may interchangeably be used. A PE is a file format for executables, object code, dynamic-link libraries (DLLs) files and the like, used in 32-bit and 64-bit versions of Windows operating systems (OS). The PE format is a data structure that encapsulates the information necessary for the Windows OS loader to manage the wrapped executable code. In some embodiments, the terms “portable executable” or “PE” as used herein refer to PE file format of .exe type.

According to some embodiments, the term dynamic analysis is directed to an analysis approach of unknown malware, which refers to the analysis of a program's behavior, captured during its execution, usually in an isolated environment (e.g., Sandbox).

The main analysis approaches of unknown malware are static and/or dynamic. In static analysis, the extraction of necessary information regarding the inspected file is done directly from the file's structure or content without executing it. However, static analysis is vulnerable to various evasion methods such as code obfuscation, packing, encryption, and dynamic code loading. This significant drawback of static analysis led to the development of dynamic analysis. Dynamic analysis is much more robust than static analysis and enables the collection of more extensive information which cannot be obtained using static analysis methods (e.g., systems' API calls and their timestamps). According to some embodiments, dynamic analysis is used to detect unknown malware based on identifying the similarity of its dynamic behavior to the behavior of known malware, and thus it allows to detect also unknown malware, a capability that signature-based approaches (e.g., antimalware tools) lack.

Dynamic analysis is usually performed using a sandbox tool that enables the execution of an untrusted program in an isolated environment without endangering the host operating system. According to some embodiments, a dynamic analysis is performed when conducting behavioural-based malware detection, i.e., to determine the maliciousness of a program based on the activities performed (or intended to be performed) during its execution.

According to some embodiments, as disclosed herein, dynamic analysis enables to collect time-oriented information regarding the examined programs. According to some embodiments, this kind of information is leveraged with various advanced temporal analysis methods to detect and identify malware and to both explain the malware behavior and to improve malware detection capabilities.

According to some embodiments, the term “temporal abstraction” (“TA”) refers to a temporal analysis technique which reduces the granularity of the raw multi-variate time series data (MTSD) to gain more contextual knowledge. For TA, instead of looking at each data point in time as a momentary event, one can look at the data as a set of events with durations, i.e., time-intervals, with an abstract value describing the event. Using time intervals instead of momentary data points is more suitable for data mining procedures and contributes to the explainability of the process, as it improves human readability. In addition, the use of time intervals with TA can reduce random noise in the data, enable large amounts of data to be succinctly summarized, improve algorithms' ability to cope with missing values, as well as improve the ability to handle data sampled at different granularities and frequencies. The abstract value of the time interval provides information about the event in terms of State (low, medium, or high) and Gradient (decreasing, increasing, or stable). Usually, a preliminary stage of discretization of the raw data is required before applying some TA procedures. The discretization enables interval generation by concatenating consecutive data points with the same discrete value (for example, State'Low). The TA phase converts the raw data into a set of intervals with abstract values describing the events that occurred. In most cases, certain events may occur concurrently, i.e., relationships can be defined between different intervals.

As used herein, a temporal pattern (TP) refers to a set of time intervals that have temporal relations therebetween. The process of identifying temporal relations between time intervals in order to generate TPs is referred to herein as “TP mining”. The TP mining process can lead to the identification of large numbers of TPs, however not all patterns identified are representative or informative for future learning process. Therefore, interestingness measures may be used to filter out the less beneficial patterns and focus the learner on the most interesting ones.

According to some embodiments, the term “vertical support” (VS), as used herein relates to a method filtering out the less beneficial temporal patterns and keeping the most informative temporal patterns. VS is the maximum frequency of a specific TP among all of the samples, i.e., files belonging to a specific class. The term sample/s as used herein is directed to a file sample, which is a file using as a sample, the terms file/s and sample/s may be used interchangeably). For example, to calculate the VS value of TPⱼ among Class_{M}, the number of unique entities in Class_{M} containing TPⱼ is divided by the total number of entities belonging to Class_{M}. The resulting VS can be denoted as VS_{M,j}. This calculation is performed separately for each class in the data, and the final VSj is the maximum value among all of the classes. Before TP mining begins, a VS threshold must be set to determine which TPs are considered frequent.

In addition to the VS which is calculated vertically across all data samples of a specific class, the horizontal support measurement is calculated horizontally in a sample-wise manner. Since a certain TP might appear multiple times within a single sample, the horizontal support represents the frequency of a TP within a sample (i.e., files).

As used herein, the term “binning” is directed to temporal aggregation of samples' API calls momentary occurrences to bins (time units), for identification of temporal patterns. For example, the time units may be in the range of about 0.5-3 seconds, such as, for example, 1 second.

According to some embodiments, mining time interval-based TPs is essentially not possible for all types of raw multivariate time-series data (MTSD), as there is a need for the time points of the raw MTSD to have numeric values upon which the TA process can be applied. For example, mining time interval-based TPs cannot easily be applied to momentary occurrence-based data, such as the API calls invoked during PE execution. These API calls events, which are very common among malware detection models, only indicate when an API call was invoked, meaning that they provide a binary representation of occurrences rather than something more informative, such as the intensity of the occurrence rate.

According to some embodiments, the methods of the present disclosure are configured to enable mining TA and TPs from momentary occurrence-based MTSD, and specifically from API calls, by first binning the raw MTSD of the API calls and then calculating an event occurrence rate for each API call within each bin, in order to convert the momentary occurrences of API calls into numerical events. This data conversion method is generic and can be applied to various domains (e.g., neuronal activity) where there is a need to convert momentary occurrence-based events into MTSD with suitable values for TA and TP mining.

According to some embodiments, the term “active learning” (“AL”) as used herein is directed to a machine learning approach that allows the active and intelligent selection of unlabelled samples based on their potential contribution to improving the model's generalization capabilities.

According to some embodiments, there is provided herein an active learning framework which enables a selection of a small yet informative subset of selected unlabeled TP files to be labeled and used to update the detection models. Selection criteria for non-time oriented data are well known in the art, however, a selection criteria for time oriented data such as MTSD data and more specifically when the MTSD is represented by time-interval TP-based data, does not exist in the art. Accordingly, in accordance with some embodiments, novel selection methods and their criteria for MTSD data when it is represented by time-interval TP-based data are provided. Based on sample's TPs, the selection criteria are calculated, for each unlabelled sample, that is potential to be added to the training data, then, those samples with the best calculated scores are being acquired into the model's training set, and the model is being retrained on the extended training set.

According to some embodiments, an AL selective sampling approach, may be implemented, where PE files were selected from a pool of unlabeled PE files. This approach is also called herein pool-based approach.

According to some embodiments, the AL framework disclosed herein utilizes an AL indirect method which is independent of any model, and a selection score which is not based on the learning model's theory. Thus, the selection is not determined by the model's outcome (for example, error reduction, a selection approach which tries to estimate the expected error of the induced model and selects samples that reduce it). Advantageously, as indirect selection methods are generic, they can be used for any type of model and reduce the complexity of the AL process, because they do not require inference for each of the new unlabelled sample.

According to some embodiments, during dynamic analysis, some of the information obtained is a record of the system API calls invoked by the examined file. The application programming interface (API) is part of the core of the Windows operating system (OS). Windows API calls, also known as API functions, are predefined procedures that perform common tasks, such as system services, networking, and security. There are two levels of interaction between the programs and the OS: user level and kernel level. API functions that provide services within the kernel level are often called system calls. While user-level API calls are usually associated with higher-level information, kernel-level system calls are associated with lower-level information regarding the services provided by the OS. Since API calls contain information regarding actions performed in the OS, they can represent the examined program's behavior and therefore can be used to reveal malicious activities of malware. Most existing dynamic analysis tools enable the hooking of the API calls as they are considered effective for detecting malware. According to some embodiments, both kernel-level and user-level API calls may be used to exploit all the information available regarding the events that occurred.

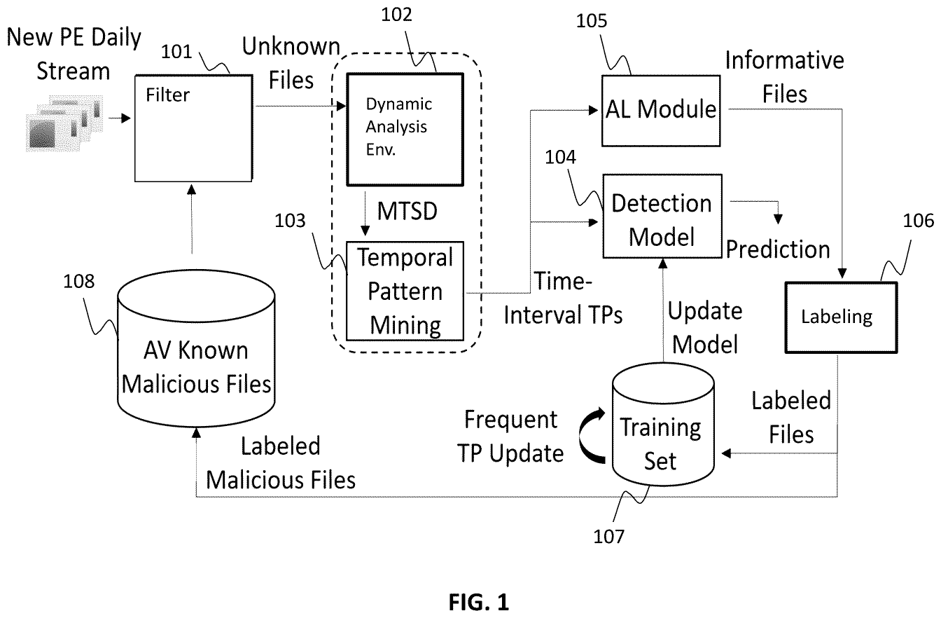

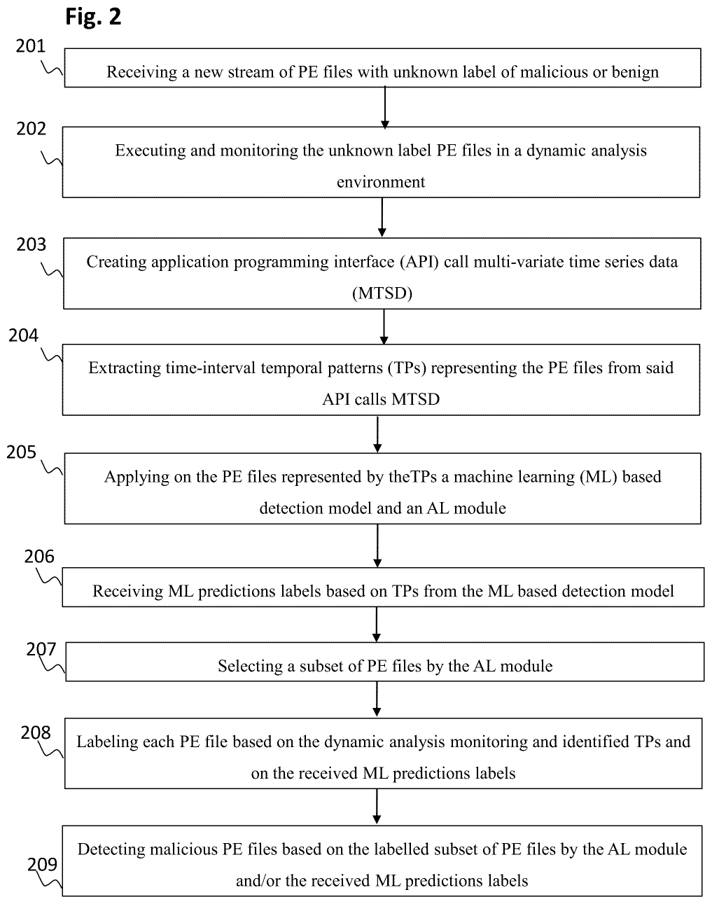

Reference is now made to FIG. 1 which shows a schematic block diagram of a framework for detecting unknown PE malware using dynamic analysis and temporal patterns based active learning, according to some embodiments, and to FIG. 2 which schematically shows a flowchart of a method for detecting unknown PE malware using dynamic analysis and temporal patterns based active learning framework, according to some embodiments. The framework includes an unknown malware filter 101, that is configured to filter out the already known malware using anti-virus (AV) tool's repository of malicious signatures of known malicious files 108, a dynamic analysis environment 102, a temporal pattern mining module 103, a machine learning (ML) based detection model 104, an active learning (AL) module 105, a labeling module 106 which may require human expert's involvement, and a ML training set 107. At step 201, filter 101 receives a new stream of PE files whose label as malicious or benign is unknown. A new stream of PE files may be received on a daily basis, or in any time frame. Filter 101 is configured to compare the unknown PE files to the malicious file signatures in the antimalware tool repository 108 and outputs only the PE files with the unknown label. At step 202, the unknown PE files (both malicious and benign) are executed and monitored in the dynamic analysis environment 102, and a dynamic analysis report is generated for each PE file. At step 203 API call MTSD are created using the binning method as disclosed herein. According to some embodiments, the dynamic analysis environment 102 is configured to enable the creation of the API calls MTSD. At step 204, time-interval TPs are extracted by the TP mining module 103. The TPs serve as the final representation of the PE files and may be referred to herein as TPs files. According to some embodiments, at step 205 the PE files represented by the TPs are sent simultaneously to both the ML-based detection model 104 and to the AL module 105. According to some embodiments, for each unknown PE file, the classification step is not limited to a specific model and may be performed using a variety of ML classifiers, as further detailed herein below. At step 206, the ML detection model is configured to output prediction labels based on file's TPs, while using all or subset of file's TPs based on the ML models utilized and the feature selection method used, as detailed herein. At step 207, AL module 105 is configured to select a subset of the most informative PE files. According to some embodiments, before AL module 105 selects the subset of the most informative PE files, a selection method for selecting the subset of the most informative PE files is utilized. The selection method is configured to assign a vertical support (VS) score/value to each TP in a PE file, and to assign a VS score for each PE file, based on the VS values of the TPs of the PE file, such that the subset of the most informative files is selected according to the VS score assigned to each PE file. The PE files with the TPs with the VS values which are higher than a predefined threshold are selected. At step 208, the subset of PE files selected by AL module 105 is sent to labelling module 106. According to some embodiments, labeling module 106 is configured to label the selected PE files. The labeling may be performed automatically, semi automatically and/or manually (for example, by a human expert), to determine the true label of (each) PE file by examining the dynamic analysis report generated for it and its identified TPs. In addition, the predictions obtained from the ML model 104 may serve as an additional indication regarding the selected PE files maliciousness and thus may aid to determine the true label thereof. At step 209, malicious PE files are detected based on the labelled subset of PE files by the AL module and/or the received ML predictions labels. The labelled files are being added to the training set 107 (with their identified TPs and VS scores, respectively) of ML based detection model 104 and the AV known malicious files module 108. The VS scores of the files' TPs are updated accordingly, and this might affect the TPs in terms of whether or not they are considered frequent. The new set of frequent TPs is the one on which the updated detection model is based on. The labelled PE files are added to the training set 107 of the detection model, and the files that were labelled as malicious may also be added to the antimalware tool's malicious signature repository 108 to improve its detection capabilities.

According to some embodiments, the AL module setup is pool-based, where each time period (for example, a day), a new set of unlabelled samples of PE files arrives. Given various limitations (e.g., time and budgetary), only a limited number of files can be manually labelled. As detailed below, in the experiments carried out to validate the AL framework of the present disclosure, the number of files to be manually labelled was set at a fixes number, for simplicity. According to some embodiments, the AL framework presented does not depend on a particular classifier but rather is based on the TPs mined in the initialization training phase and extracted from the unlabelled files of each daily stream. Thus, the presented AL framework and selection methods of the present disclosure may be considered indirect methods.

According to some embodiments, the AL methods are configured to update the list of frequent TP files based on the change in the VS scores occurring as a result of the acquisition of new samples (i.e., the labelling of new unknown TP files as malicious or benign). The detection model may be updated based on the new training set and the new list of frequent TPs.

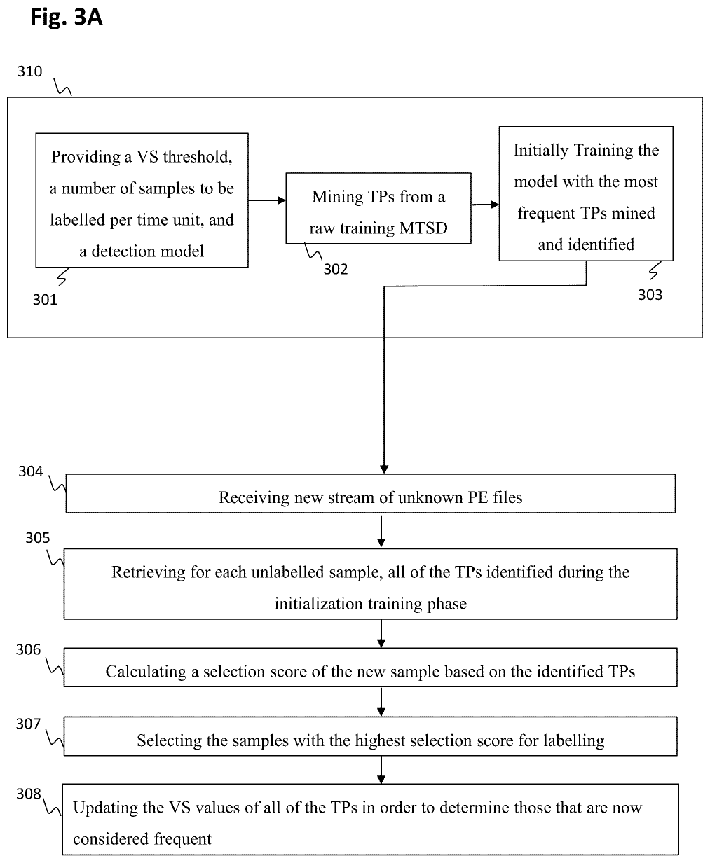

Reference is now made to FIG. 3A which schematically shows a flowchart demonstrating the use of TPs in an AL framework, according to some embodiments. An initial training phase 310 includes steps 301, 302 and 303. At step 301, provided/defined are a VS threshold, a number of samples (i.e., files) to be labelled per time unit, and a detection model. For example, the number of samples may be a fixed number of samples or a varied number of samples in each time unit. According to some embodiments, the samples may be manually labelled or, automatically labelled by a labelling module. The labelling is per a time unit, for example, each day, per a predefined number of hours and the like. At step 302, the initialization of the AL framework starts, with mining TPs from a raw training MTSD. At step 303, the model is trained using the most frequent TPs mined and identified, and the initial training stage is done. At step 304, new stream of unknown PE files are received to the framework, where the stream may be a daily stream, or any other frequency of stream. At step 305, for each unlabelled sample, all of the TPs identified during the initialization training phase 310 are retrieved in order to represent the sample. According to some embodiments, at step 306, the selection score of the new sample is calculated based on the identified TPs using one of the selection methods as detailed below herein. Then, at step 307, the samples with the highest selection score are selected for labelling. For example, the samples with the highest selection score may be selected according to a predefined threshold of the top K samples with the highest selection score. According to some embodiments, the labelling may be a manual labelling or an automated labelling. Finally, at step 308, the VS values of all of the TPs are updated in order to determine those that are now considered as frequent. The frequent TPs may then be used to update the detection model.

FIG. 3B schematically shows an example of a pseudocode implementing an algorithm for using TPs in an AL framework, according to some embodiments.

According to some embodiments, the dynamic analysis environment may be a sandbox, such as, for example a Cuckoo sandbox. According to some embodiments, the sandbox is configured to generate reports with the execution details of the unknown PE files and from the reports the API calls MTSD are created. Of the information contained in the reports, the API calls invoked during the execution of the examined file may be extracted. More specifically, in some embodiments, the names of the API calls and the exact timestamps in which they were invoked, may be extracted.

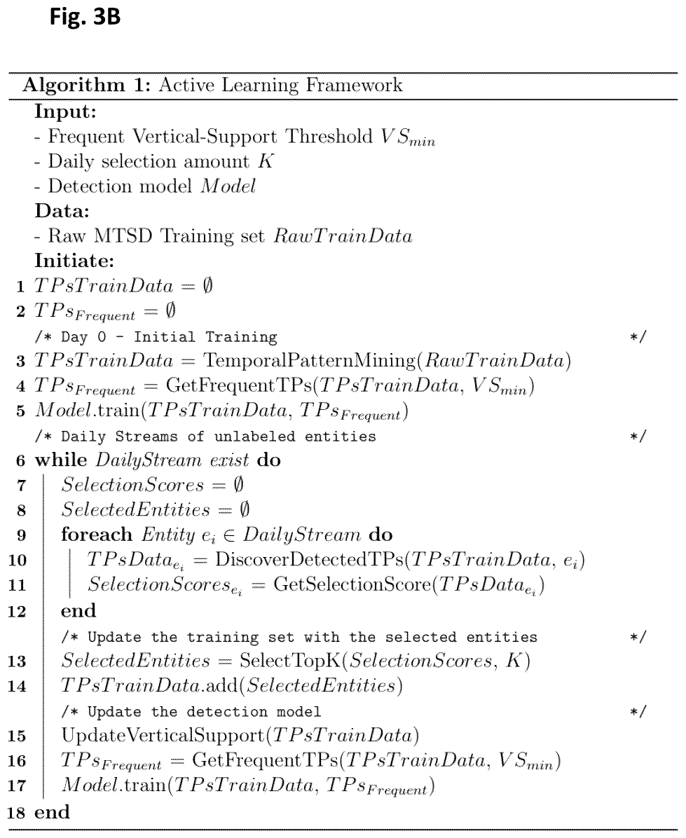

According to some embodiments, after running the PE files in a sandbox environment, the relevant information is extracted from the Cuckoo reports; this information may later be used to mine time-interval TPs, induce a model, and perform the malware detection. Of the information contained in the reports, of interest are the API calls invoked during the execution of the examined file, including the names of the API calls and the exact timestamps in which they were invoked. Reference is now made to FIGS. 4A-4B, which show an example of detecting an AIP call event in a sandbox report. Shown in FIG. 4A is an API call event captured in a cuckoo sandbox report, according to some embodiments. In the example shown in FIG. 4A, the API call event name is NtDelayExecution API call event which delays the execution of a current thread. For each API call event documented in the report, the API name 401 and timestamp 402 are extracted in order to build the raw API call MTSD table, shown in FIG. 4B, which shows an exemplary raw API call MTSD table, according to some embodiments. The table lists the API calls (listing the API name/type) and the corresponding time stamp. The table further includes a file column denoted as ID which lists the name of the file such as F1, F2 . . . Fn, and a “label” column, indicating if the file is malicious (1) or benign (0)

According to some embodiments, it is desired to learn and extract the complex temporal relationships that exist between the API calls to better characterize the behavior of the analysed file. According to some embodiments, there are more than 300 different API calls. Each is considered a single variable. The reason data with this structure is referred to as raw MTSD is because usually, when dealing with MTSD, each feature in the time series has a measured value. API calls, on the other hand, do not contain a measured value due to their binary nature. According to some embodiments, in order to be able to perform TA and mine time-interval TPs, a meaningful numeric value needs to be assigned to each API call event. These values should, to some extent, provide information about the event (such as its intensity). According to some embodiments in order to overcome this hurdle, the frequencies of the API calls, referring to it as occurrence rate may be used. In order to preserve the temporal structure of the API calls, each PE time execution sample's (i.e., file) raw MTSD is divide into equal sized bins, and the occurrence rates of the API calls that appear in each bin is calculated. Although this binning may reduce the granularity of the raw MTSD, it advantageously allows to smooth the data, cope with noise and missing values, and to aggregate many momentary events with temporal proximity in order to produce a more informative representation that allows to perform TA. The bin size selected has direct impact on the temporal resolution of the resulting MTSD, meaning that too large a bin size will result in the aggregation of events from many timepoints into a single point and leads to a significant loss of temporal information. On the other hand, a bin size that is too small might create a very granular time-series that is almost identical to the raw MTSD. This would cause the occurrence rate to become less informative for the TA phase.

As demonstrated herein, in an exemplary execution of PE files, an average execution duration of the PE samples was about 200 seconds, so the bin size, in this case was set at one second, since it provides a good balance between the resulting number of data points and the ability to aggregate enough API call events. In this case, there was an average of 42 API call occurrences in a single bin. In some embodiments, an average execution duration of the PE samples may be about around 50-400 seconds, and the bin size may be set at about 0.5-5 seconds.

According to some embodiments, for some of the abstraction types applied in the TA phase, a preliminary phase of discretization of the occurrence rate values of the API calls at the various timepoints in the MTSD may be performed (for example, replacing the measured values with low, medium, and high indicators). Since API calls represent low-level actions, in some instances it may be impossible to manually determine which occurrence rate is considered as normal. Thus, knowledge-based discretization may not be possible in this case, and automatic methods must be used. Equal width discretization (EWD) is one such method. EWD divides the measured values' space into K equal discrete levels; this is accomplished by calculating the cut-off step which determines the range of the levels. Equation (1) presents the EWD calculation,

$$W = ( {V}_{max} - {V}_{min} ) / K \qquad ( 1 )$$

where Vₘₐₓ and Vₘᵢₙ respectively denote the maximal and minimal values in the data, K denotes the number of desired discrete levels, and W denotes the cut-off step. For example, K may be set to K=3, meaning that the occurrence rates of API calls is divided into three discrete levels: low=[Vₘᵢₙ, Vₘᵢₙ+W), medium=[Vₘᵢₙ+W, Vₘᵢₙ+2W), and high=[Vₘᵢₙ+2W, Vₘₐₓ). It should be noted that discretization is performed variable-wise, as each variable may have different value range.

According to some embodiments, in the TA phase, different types of abstraction may be implemented, for example State and Gradient. The State abstraction uses the discrete values obtained as a result of the EWD procedure and creates intervals from consecutive data points of the same discrete value. The second abstraction, Gradient abstraction tries to capture the direction of the change in the measured values of the data points. Since the Gradient abstraction is generated independently of the State abstraction, it provides additional information regarding the temporal behavior of an entity. Furthermore, TA is applied in an API-wise manner, and thus it converts the momentary data points into time-intervals of a particular API with an abstracted value describing the event. For the State abstraction this value can be either low, medium, or high, and for the Gradient abstraction it can be either increasing, decreasing, or stable. At the end of the TA phase, each entity is represented with a set of time-intervals and their abstracted values (e.g., State-high, Gradient-decreasing). Based on this information, TP mining can be performed. According to some embodiments, KarmaLego framework may be used for the TP identification process. It is noted that in order to consider a TP as frequent, a VS threshold must be defined (this is discussed further in the Experimental Design section). Naturally, TPs consisting of a greater number of intervals will be rarer and therefore will not be considered frequent. Therefore, the mining process was limited to TPs constructed from one, two, or three intervals.

According to some embodiments, a non-transitory computer-readable medium having stored thereon instructions that cause a processor to detect unknown PE malware, based on time interval-based active learning framework, is provided. In some embodiments, the processor may be configured to: receive a new stream of PE files with unknown label of malicious or benign; Execute the unknown label PE files in a dynamic analysis environment; Create application programming interface (API) call multi variate time series data (MTSD); Extract time-interval temporal patterns (TPs) representing the PE files from said API calls MTSD; Apply on the PE files represented by the TPs a machine learning (ML) based detection model and an AL module; Receive ML predictions labels of the TPs from the ML based detection model; Select a subset of PE files by the AL module; Label each PE file based on the dynamic analysis and identified TPs and on the ML predictions labels; and Detect malicious PE files based on the labeled subset of PE files by the AL module and/or the received ML predictions labels.

### Malware Detection Using Frequent Temporal Patterns

According to some embodiments, the malware detection phase may be performed by inducing ML-based models that leverage the TPs found in the previous stage for example, by using only the frequent TPs based on a predefined threshold of vertical support (VS). This is due to the assumptions that frequent TPs are more informative and essential for the learning process and that using all of the TPs identified (including the infrequent ones) just add noise and unneeded variance to the feature space which can impair the detection models' capabilities. The frequent TPs represent common behavior of the class in which they were identified, and since the VS of each TP is calculated for each class individually, these common behaviours become a characteristic of the different classes and therefore are informative and have a predictive capability regarding their class. In addition, the VS used is moderate and not extremely high or low (ranging between about 20/% and 30%). Thus, it was able to identify TPs that are considered frequent in more than one class. However, the distributions of these mutual TPs vary widely among the different classes, a fact that strengthens the ability of frequent TPs to characterize malware or benign samples (PE files). Since it is desired that the detection models be able to generalize, using rare TPs that appear in a limited number of files may lead to a large sparse feature space and, in some cases, to overfitting, since the TPs that might be used as features will only appear in the training data. The frequency of each TP is determined by its VS value, which is calculated for each class individually. To decide whether a particular TP is considered frequent, the maximum VS value is used between the two classes and compare it to a VS threshold set at the beginning of each experiment. For example, given TPⱼ, if its VS among the malicious class (VS_{M,j}) exceeded the defined VS threshold and its VS among the benign class (VS_{B,j}) did not, it will still be considered as frequent, since the maximal value between VS_{M,j} and VS_{B,j} is higher than the threshold. As the VS is calculated individually for each class, frequent TPs may represent typical behavior of samples in that class. In this case, the TPs that appeared in a significant percentage of malicious samples may represent malicious behavior.

According to some embodiments, the disclosed AL framework and selection methods are generic and are not limited to a specific ML classifier. To this aim, and to demonstrate the ability of the AL methods of the present disclosure, the following four ML classifiers were used: 1) Temporal Probabilistic proFile (TPF), which is a TP-based classifier that excels in building a probability distribution of the frequent TPs identified in each sample. In order to perform the final classification, a similarity measure based on negative cross-entropy is used to compare the distributions of the different samples. 2) Random Forest (RF). 3) Support Vector Machines (SVM). And 4) Logistic Regression (LR). Unlike the TPF classifier which, as input, receives the set of frequent TPs identified for each sample as they are, classic ML classifiers require a feature vector as input. Thus, to make use of the TPs as features, the horizontal support values of each TP are used as a feature representation to calculate the TP's frequency in a specific sample. Therefore, the final feature vector of a sample is constructed from the frequencies of all frequent TPs concatenated with the sample's label.

### Active Learning Methods and Their Selection Criteria

According to some embodiments, the advantageous AL methods presented herein make use of the identified TPs to prioritize the selection of informative samples, and are thus more robust, accurate and effective as compared to using other selection methods. The selection methods can calculate a selection criterion that produces a score for each sample in the pool of samples so that it will allow selecting the K most informative ones. According to some embodiments, and as described herein, the AL framework's core of the present disclosure is based solely on TPs and is agnostic to both the final representation of the TPs and to the classifier chosen. As can be seen in FIG. 1, the input to the AL module that contains the selection mechanism consists of the raw time-interval TPs. Therefore, a comparison to other methods can be performed if the other methods can be applied directly on the time-interval TPs and do not rely on any vectored representation of the TPs which can cause biases in the selection procedure and the learning process.

The selection methods that were used for comparison with the currently disclosed AL selection methods are: 1) Random—This method is a naive approach in which K samples are randomly selected from the pool. Although increasing the training set itself may improve the performance of the model over time, it is assumed that this selection method will be the lower bound of all of the other methods presented. 2) ALL—This method follows a hypothetical scenario where there are unlimited resources (time and budget) and thus are able to acquire all of the samples that exist in the daily stream. This situation is of course not possible in the real world, but the goal here is to get a sense of what would happen if all of the samples could be acquired and labeled. Intuitively it is anticipated that this selection procedure will serve as an upper bound of the methods, assuming that the acquisition of all of the samples in the pool will not add noise to the learning process. 3) Marginal Ratio (MR)—In addition to the naive baseline methods (Random and All) presented above, to ensure that the evaluation process is as comprehensive as possible, the selection methods of the present disclosure were compared to other appropriate existing AL methods. As mentioned, to perform a valid and fair comparison, it is necessary to use methods that can analyze and leverage the entire set of TPs identified. These sets can consist of hundreds of thousands of TPs. However, existing AL methods, which are aimed at maintaining or improving the induced classifier's generalization capabilities in light of the changing reality, suffer from two main limitations: (1) They are limited with regard to the number of features they can process. This limitation is due to the limited number of features the ML algorithm used to induce the classifier can handle, an amount which is usually much less than the number of TPs identified. (2) They cannot be applied directly on the TPs without first applying feature representation (e.g., binary, TF-IDF), a step which is usually associated with some information loss. Thus, in order to perform a comparison to an existing method an uncertainty-based selection method called Simple-Margin was chosen and a time-interval TP variant of it inspired by the theoretical concept underlying Simple-Margin was created. The Simple-Margin method was designed for the SVM classifier, and it selects the samples that lie closest to the separating hyperplane's margin. These samples are assumed to be more confusing to the classifier, and the classifier is less confident regarding their classification. The new information available for the learning process (obtained by acquiring the samples) could be valuable, as the classifier is being sustained with informative samples whose classification it is not confident about. In its original form the method is not suitable for leveraging time-interval TPs and does not meet the basic conditions for comparison presented earlier. Thus, a time-interval TP variant of the Simple-Margin method was developed, referred to herein as Marginal-Ratio (MR), which can perform the selection based solely on the TPs.

According to some embodiments of the present disclosure, in the AL framework, the detection model is trained on the frequent TPs which are determined based on their VS values in the training set. Frequent TPs are more informative, because they represent behavior commonly seen in the data, while rare TPs can impair the model's ability to generalize. Thus, the TPs that lie close to the VS threshold can be seen as confusing or “marginal” TPs, since their definition as frequent or infrequent is not significant. Following the principle of the

Simple-Margin method, the TPs' proximity to the VS threshold in each sample can be used and thus prioritize the acquisition of confusing samples. Note that a sample that encompasses a larger number of “marginal” TPs is more likely to be informative to the learning model, as its addition (along with its TPs) to the training set will affect the VS of those marginal and critical TPs. Accordingly, a selection method can be formulated so that it will favor and select samples with a relatively high number of TPs located close (i.e., within a predefined margin) to the defined VS threshold. Another concept of the Simple-Margin method is that by acquiring marginal samples, the chances of having a more significant impact on the SVM's separating hyperplane increase and therefore impact the classifier. Similarly, in the MR method, regardless of the classification algorithm, acquisition of marginal TPs is more likely to cause the VS of the marginal TPs to increase, and therefore, prioritizing samples with marginal TPs will have greater impact on the set of frequent TPs and thus more significant impact on the classifier. The margin limits are referred to as the lower bound (LB) and upper bound (UB). According to some embodiments, the margin limits may be defined as about 1% above and 1% below the chosen VS threshold. Equation (2) shows the MR method's calculation of the selection score. For a given sample sᵢ, based on the entire set of TPs that were identified in sᵢ, the number of TPs that are within the VS margin divided by the total number of TPs identified in sᵢ (denoted by N). The VS value of the j'th TP is calculated for the malicious and benign class separately, which are denoted as VS_ (M,j) and VS_ (B,j) respectively. To determine whether a TP is considered marginal, the maximum VS value between the two classes is used. Samples with a relatively high number of marginal TPs will receive a higher score.

$$M R ( {s}_{i} ) = \frac{1}{N} {Σ}_{j = 1}^{N} {1}_{LB < max \{ {VS}_{M , j} , {VS}_{B , j} \} < U B} \qquad ( 2 )$$

According to some embodiments of the present disclosure, a first selection method for the AL module in the AL framework may be Malicious Score (MS). The task of prioritizing the acquisition of malicious samples from a pool of unlabeled samples adds difficulty to the overall AL task. However, when it comes to malware detection, the importance of this prioritization increases significantly for three main reasons: 1) First, there is a need to increase the signature repository of malicious files as part of improving the capabilities of antimalware tools that rely on such repositories. 2) Second, in most cases, the proportion of malicious files of the total number of files entering organizations daily is very small, which means that in real-life scenario, detection models must deal with an imbalanced data problem. Thus, increasing the number of malicious files in the training set will reduce the level of data imbalance, which may improve the performance of the detection model over time. 3) Lastly, malicious files contain more information and have more variability than benign files, thus acquiring more malicious files is more beneficial in terms of enhancing the model's generalization capabilities. The MS AL method heuristically favors samples with TPs for which the malicious VS is larger than the VS in the benign class. Although the sample's true label is unknown, its identified TPs' distribution among the malicious samples in the training data can still be used to infer its level of maliciousness. Equation (3) shows the MS method's calculation for an unlabelled sample sᵢ. The maliciousness of each TP is calculated by an exponent to the power of the difference between the TP's VS values for the two classes. Based on this calculation, samples for which there is a higher rate of TPs associated with the malicious class than the benign class (in the training data) will receive a higher score and thus their chances of being selected will increase and visa versa. Since this method selects samples that are associated with the malicious class, it can be categorized as a representativeness-based method.

$$M S ( {s}_{i} ) = \frac{1}{N} {\sum }_{j = 1}^{N} {e}^{( {VS}_{M , j} - {VS}_{B , j} )} \qquad ( 3 )$$

According to some embodiments, a second selection method for the AL module in the AL framework may be Marginal Malicious Score (MMS). Here, the two methods mentioned above are combined: MR and MS. The goal here is to examine whether by combining the information about the ratio of the marginal TPs with information about the maliciousness of the sample, the performance of the learning model can be improved compared to using each of the methods separately. Equation (4) presents the method's scoring calculation which uses a linear combination of the two selection methods with a coefficient β that determines the weight of each method in the final score. According to some embodiments, in an exemplary experiment described below, β was set to be β=0.5 so the final score will be the average of both methods. Note that the value range of the MS method is greater than the possible value range of the MR method, and therefore its effect on the average score will be stronger. This situation was chosen intentionally, since in any situation it is desired to prioritize the selection of malicious samples.

$$M M S ( {s}_{i} ) = ( 1 - β ) * M R ( {s}_{i} ) + β * M S ( {s}_{i} ) \qquad ( 4 )$$

According to some embodiments, there is thus provided herein a PE malware detection framework that enhances existing antimalware tools by performing dynamic analysis on the unknown PE files, mining informative time-interval TPs based on API calls, and leveraging them both for accurate malware detection and the active selection of informative files to be manually labelled. The new files labeled are used both to update the detection model and to expand the malicious file repository of a signature-based antimalware tool. According to some embodiments, two time-interval TP-based selection methods (MS and MMS) are provided that consistently prioritize the selection of malicious samples and improve the detection capabilities of various ML classifiers. In addition, it was shown that the use of time-interval TPs in AL enables the identification of malicious trends that can assist cyber experts in dealing with future attacks.

According to some embodiments, as exemplified herein, the methods have been evaluated by performing an extensive set of experiments using a total of 9,328 PE files. In the first experiment the results clearly showed that both the MS and MMS methods could prioritize the selection of malicious samples by using only the TPs identified in each file and considering the VS values of those TPs in the training set. According to some embodiments, the MMS method also gives weight to samples with TPs located in the VS margin, and thus it acquired a smaller amount of malicious samples than the MS method but much more than the MR and Random methods. The results of the Random method were consistent with the fact that a random sampling from the daily streams would result in the selection of malicious samples proportional to their prior probability. The low acquisition results of the MR method can be explained by the fact that this method does not distinguish between the malicious and benign VS values.

According to some embodiments, in the second experiment, overall, the results showed that the time-interval TP-based AL framework of the present disclosure, improved the performance of the learning models over time. Furthermore, the herein disclosed MS and MMS selection methods outperformed the traditional MR and Random methods for all four classifiers, and in some cases, managed to outperform the ALL-hypothetical scenario. This shows that in some cases, acquiring all of the daily data available actually impairs the learning process. In addition to looking at the nominal detection results, it is important to look at the differences between the selection methods. Naturally, when increasing the training set it is assumed to see a certain improvement in the model's capabilities, and thus the Random and MR methods also showed an improvement in the model's performance over time despite their selection process. Therefore, the fact that the methods of the present disclosure achieved better results than those baseline methods with all four classifiers further shows their robustness. An in-depth review of the results and examination of the FPR values obtained, shows that the MS and MMS selection method of the present disclosure, caused a slight increase in the FPR values over the 10-day period; this makes sense, since the FPR denominator gets smaller when the acquisition of positive samples (malicious) is prioritized. Despite the increase in the FPR values, they are still relatively small considering the high detection results obtained.

According to some embodiments, the MS and MMS methods are designed to consistently increase the number of malicious samples in the training set. Since the initial training set is highly imbalanced, increasing the number of malicious samples and reducing the level of data imbalance may result in improved model capabilities. Regardless of the imbalance problem, malicious files naturally have more variability in their behavior than benign files, and therefore their addition to the training set contributes to the learning. In addition, according to some embodiments, since the MS and MMS methods also acquire some benign files, those files are thus very informative, because they received a high maliciousness score. Thus, adding those acquired benign files to the training set is extremely valuable. Regarding the results of the SVM classifier on the remaining malicious files, the MS and MMS methods yielded higher detection results than other tested methods. The gap observed between these methods and the baselines, including the ALL baseline, is due to the fact that this test set contained only malicious files, and therefore the expansion of the training set with malicious files lead to an improvement in the model's detection capabilities. In a use case where the detection of malicious files is more valuable than the detection of benign files, capabilities of this kind are of greater importance.

According to some embodiments, the results of the third experiment show that even for different daily selection amounts, the selection methods of the present disclosure still received the highest detection results. As the daily acquisition amount increases, the capabilities of the detection models improved as the size of the training set increased. In addition, increasing the daily acquisition amount reduces the gaps between the various selection methods, as the size of the daily stream is fixed, and therefore the number of possible selection options decreases.

According to some embodiments, the time-interval TP-based AL framework's potential capabilities, and its ability to identify malicious trends which are revealed as a result of the acquisition of new informative samples are demonstrated in the fourth experiment below. The importance of using TPs is also in the aspect of the explainability of the emerging trends. Since the TPs represent behavior that occurred during the execution of the files, a cyber expert examining this information will be able to draw conclusions that would not necessarily have been possible if he/she had examined other features (for example, the raw API calls). It is important to note that the volatility in the VS values is directly related to the number of files in each class. When the relative share of a particular class in the data is large (as in the benign class in this case) less volatility is observed and vice versa. Thus, since the data is highly imbalanced, to conclude that a certain behavior is indeed a malicious trend, it is not enough to only examine the increase in the malicious VS, and it is also important to examine how the benign VS behaves. In the example presented herein, a consistent decrease in the benign VS and a significant increase in the malicious VS can be seen. Another element of explainability resulting from the herein disclosed temporal pattern-based AL framework is the ability to analyze the factors that influence the detector's prediction. Since only TPs that crossed the VS threshold are frequent and were used by the classifiers, one can examine the distribution of the TPs identified in each file and therefore gain a better understanding of what might have led to the specific prediction (for example, an emerging malicious trend that gained popularity among the acquired malicious samples).

According to some embodiments, as exemplified in the fifth experiment, the long-term performance of three ML model that uses MS and MMS methods were compared to their traditional and non-AL-based version k. The results clearly show that models that are not frequently updated are unable to reflect the changing reality and do not improve over time, unlike the models that acquire informative samples daily and are frequently retrained which enables their improvement over time, as in the currently disclosed AL framework.

In the description and claims of the application, the words “include” and “have”, and forms thereof, are not limited to members in a list with which the words may be associated.

As used herein, the term “about” may be used to specify a value of a quantity or parameter (e.g., the length of time) to within a continuous range of values in the neighborhood of (and including) a given (stated) value. According to some embodiments, “about” may specify the value of a parameter to be between 80% and 120% of the given value.

As used herein, according to some embodiments, the terms “essentially”, “approximately”, and “about” may be interchangeable.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

### EXAMPLES

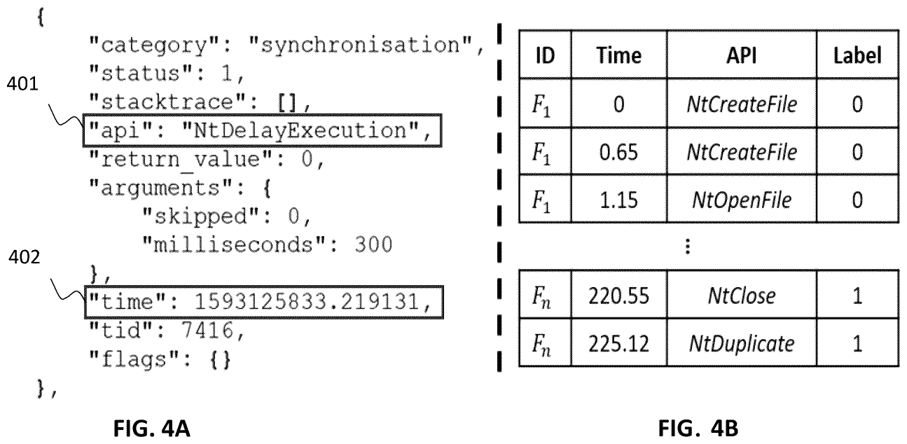

Reference is now made to experiments made to validate and assure the advantages of the herein provided methods. According to some embodiments, in order to create a data collection, it was needed to gather a representative and sufficient amount of malicious and benign PE files. The malicious file repository was obtained from VirusTotal, a web-based service that aggregates multiple antimalware engines and provides various scanning services. The files used are those files that the majority of antimalware engines tagged as malicious and whose family label was decided based on a majority vote among the different engines. The benign file repository mainly contains freeware PEs collected largely by a research center. It also includes executables from the system32 folder of a clean machine installed with the Windows 10 OS. To verify the label of these files, the VirusTotal API was used so that every file detected by at least one antimalware engine as malicious was removed from the benign file repository. In addition, in order to reduce the chance of using malware with anti-virtualization capabilities, a YARA rule indications was used. YARA is a repository of static rule-based indicators which uses regular expressions extracted from a file's binaries to issue alerts on potential malicious abilities. All of the files collected were analyzed in the dynamic analysis environment of the cuckoo sandbox, so that for each file a report that documents the API calls invoked during the execution was generated and the YARA indications (if found) were extracted. It is noted that some malware samples are able to detect that they are running in a virtual environment and therefore refrain from performing malicious actions or stop altogether. In addition, there is a chance that a file, regardless of whether or not it is malicious, was not successfully executed during the analysis. This will be reflected in very poor API call documentation (this could occur in the case of a defective file, inability of the sandbox environment to run the file, etc.). According to some embodiments, in order to avoid using uninformative PE files, the following steps were performed. First, a minimum API call threshold was set at 15, files containing less than 15 API calls were removed from the data collection. Second, files containing anti-virtualization YARA indications were also removed from the data collection. Table 1 presented at FIG. 5 shows the distribution of families and file types in the final data collection. Overall, the final data collection contained 9,328 executables files of which 5,000 were benign and 4,328 were malicious.

### 1) Enriching AV Tools' Malware Signature Repository

This experiment tests the ability of the herein presented AL methods to prioritize the selection of malicious samples in a daily stream in order to enrich the antimalware tools' signature repository and keep it updated so it reflects the daily creation of new malware. To do so, selection method of the present disclosure MS and MMS and known baselines selection methods Random All and MR must be examined in an AL scenario that simulates a realistic environment in which a stream of unlabelled samples arrives daily, from which a predetermined number of samples need to be selected for labelling, (optionally manual labeling). Note that this experiment is not addressing the detection models' capabilities. A realistic scenario of AL in the malware detection domain includes, among other things, dealing with imbalanced data. Thus, to reflect reality as much as possible, the experiment was performed on data in which only 10% of the files are malicious and the rest are benign. Out of the total 9,328 files in the data collection, all of the 5,000 benign files were used, and an additional 556 malicious files were randomly selected. Twenty percent of the 5,556 files were randomly selected to serve as an initial training set on which the TP mining process was performed. It is noted that the random file selection was performed in a stratified manner, maintaining the 10% malicious/90% benign file ratio in the initial training dataset as well. The rest of the files were used to support a 10-day experiment where every day a new daily stream is used to simulate the arrival of new unlabelled data samples. The allocation of files to daily streams was performed randomly but in a stratified manner so as to maintain the 10% malicious/90% benign file ratio in each daily stream as well. (In practice, the remaining 80% of the files that were not selected to be in the initialization set were split into 11 daily streams to be used in the next experiment.) Thus, each daily stream was composed of about 405 samples, of which around 364 are benign and about 41 are malicious. The evaluation of the selection methods was performed as follows. Based on the herein disclosed AL framework, it was started by mining time-interval TPs in the initial training set (day zero). Then, in each daily stream of the 10-day period, the selection scores of the unlabelled samples were calculated using the examined selection method and select the top-k samples to update the training set and the VS values of the TPs. K, the number of samples selected each day, was chosen to be set at 100, as it is believed it is a reasonable number which on the one hand allows the training set to be enriched with enough new information and on the other hand represents a manageable amount/number of samples for a human expert to manually examine. Experiment 3 (described below) examines the impact of different K values. These steps were applied for each of the selection methods introduced above to evaluate their ability to prioritize malicious samples. In addition, to avoid bias stemming from the random division of the samples into the initial training set and daily streams, a standard cross-validation was applied in which the division was performed several times and implemented each selection method on each training set/daily stream division (referred to as rounds). The results presented are an average of the multiple rounds of the experiment.

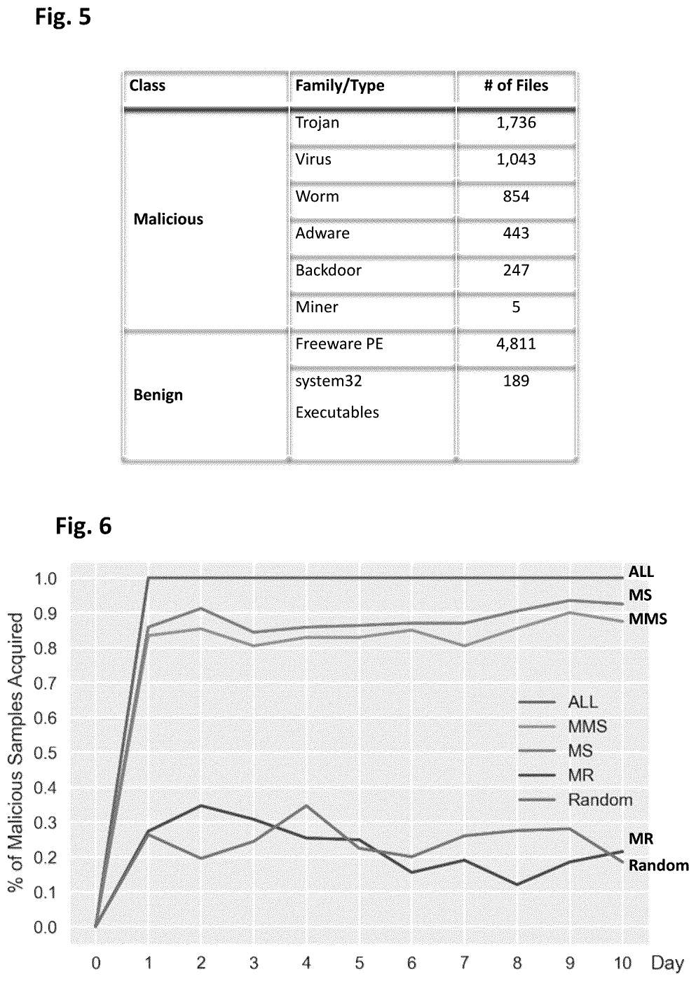

In this experiment, the capabilities of the selection methods of the present disclosure and the baseline methods to prioritize the acquisition of malicious samples were examined. FIG. 6 schematically shows the percentage of malicious samples selected by each of the selection methods from all of the malware available in each daily stream, according to some embodiments. As can be seen, the MS method maintained a high daily malware acquisition percentage (ranging from 85% to 93.5%) over the 10-day period. With slightly lower percentages, the MMS method achieved an acquisition percentage ranging from 80.5% to 90%. Unsurprisingly, the Random method selected, on average, only 24.7% of the malicious samples available for selection each day. That is, on each day, out of the 100 samples acquired by the

Random method, about 10 were malicious, which is consistent with the priori probability of malicious sample in each daily stream. Similar to the Random method, the MR method also resulted in relatively low malware acquisition percentages, selecting just 23% of the daily acquired malicious samples on average. While the ALL-hypothetical scenario is not limited in the amount of samples acquired daily and therefore chose all of the malicious samples available, it can be clearly seen that the results of the MS and MMS methods are comparable to the results of ALL. In contrast, since the Random and MR methods are not oriented towards the acquisition of malicious samples, they acquired low amounts of malicious files. The superiority of the herein disclosed MS and MMS methods is reflected here in the ability to preserve the widely used antimalware tools updated and keep their users protected, in light of the daily creation of malicious PE files.

### 2) Improving Malware Detection Capabilities

In this experiment, it was examined whether the selection methods of the present disclosure improve the performance of the detection models over time compared to the baseline selection methods. The ability to improve the ML model's detection capabilities over time not only allows the framework to cope with unknown malware that a signature-based tool has a limited ability to detect. It also allows the model to serve as a reliable decision support system (DSS) for labeling. The cyber expert can use the classification decision provided by the updated detection model regarding a particular unlabeled file as an additional indication of its maliciousness. Like in previous experiment, 20% of the data allocated to the experiment served as the initialization set (while maintaining a 10% malicious rate), while the rest of the samples were randomly distributed to the daily streams, again while maintaining a 10% malicious rate for each day. In addition, the VS threshold was set to 30%, and K was set to 100. To perform as broad an evaluation as possible to assess the ability of the various selection methods to improve the detection models' performance over time, it was chosen to examine several classifiers: Temporal Probabilistic proFile (TPF) with top-3, Random Forest (RF), SVM, and Logistic Regression (LR). For each combination of classifier and selection method, the experiment was performed as follows: The initial detection model was trained based on the frequent TPs mined from the initial training set. On each day d in the 10-day period, the d'th day detection model on the d+1 daily stream data was first evaluated to measure its detection performance. Then, based on the TPs identified in each of the unlabeled samples of the daily stream, the selection method acquires the top-k samples for manual labeling. The new labeled samples are then added to the training set, and the VS values of the TPs in the database are updated, which changes the set of TPs considered frequent and used to update the learning model. Then, the model is evaluated on the d+2 daily stream data. This process repeats itself until the tenth day when the eleventh daily stream is used for the evaluation. Note that the process of evaluating the model each day on the next day's data is performed for experimental purposes only and does not affect the process of selecting the unlabeled samples. Of course, this operation is not possible in real life as the ground-truth label of each sample is unknown until it is manually tagged, however, it can be performed in this experiment where it is aimed to measure the model's capabilities over time. It should be emphasized that although the training set is updated daily, and thus its percentage of malicious files, the malicious file percentage in the test sets (the daily streams) remains at 10% throughout the 10-day experiment, in accordance with reality. Considering that the purpose of the test set is to evaluate the performance of the model in a real scenario, it is of great importance to examine how the model deals with the imbalance problem in practice. To compare the capabilities of the methods of the present disclosure presented herein to those of the baseline methods further and utilize all of the data available, all of the malicious files that were not part of the 10-day period experiment were used (3,772 malicious samples) to evaluate the detection capabilities of the model that yielded the highest results. Since this is a set of malicious files only, the effect of the different selection methods on the true positive rate (TPR) metric of the model was compared against the theoretical scenario of selecting all samples each day. Like the previous experiment, the same standard cross-validation setup was applied to avoid bias caused by the random division of the samples into the initial training set and daily streams.

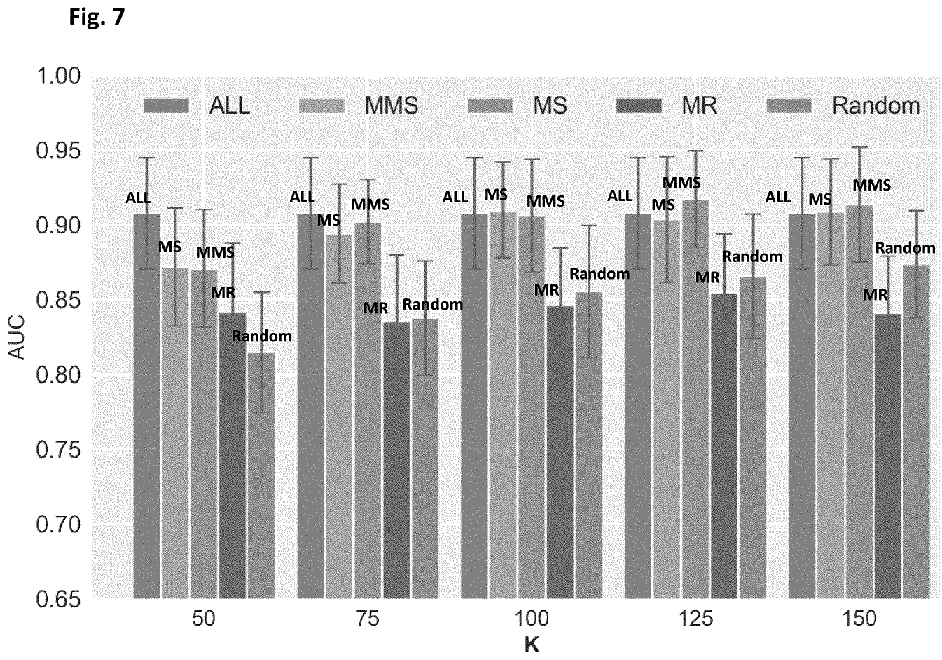

In this experiment, the ability of the various selection methods to improve ML-based detection in the long term was examined. FIG. 7 schematically presents the AUC and FPR metrics of the classification models for each selection method examined, according to some embodiments. The mean of the cross-validation operation is presented in the graph. In the AUC charts, the MS and MMS methods outperformed the MR and Random methods significantly for all the classification models that were examined. Moreover, for certain classifiers it can be seen that the MS and MMS methods also outperformed the hypothetical ALL scenario which acquires all samples available in the daily stream. These results indicate that in some cases (usually when the data is noisy) acquiring a small but informative set of files achieves better results. The SVM classifier achieved the highest detection results, which was also reflected in a higher AUC starting point of 80.47%. Using the MMS and the MS selection methods, the SVM reached an AUC of x % and 94.96% on the tenth day respectively. These methods also managed to outperform the ALL scenario almost throughout the entire 10-day period. The Random and MR methods achieved an AUC of 89.56% and 89.23% on the tenth day respectively. Looking at the SVM's FPR graph, although higher volatility was observed for the MS and MMS methods than the baseline methods, on average the FPR value ranges between 1.8% and 3.8%, and for the last days the FPR values only ranged between 2% and 2.2%. A significant improvement in both AUC and FPR is important in this case, since it indicates that the herein presented detection framework can: 1) accurately detect unknown malicious PEs, even when the data is highly imbalanced; 2) reduce the number of false alarms for benign PEs that may be essential to the organization. Overall, for the SVM classifier the MMS and MS method yielded an AUC improvement of almost 15% over the ten-day period. Not far below the SVM, the LR classifier achieved high detection results using the MS and MMS methods, with even more significant improvement over the 10-day period. The MS and MMS methods outperformed the Random and MR methods, and their results were close to those obtained with the ALL scenario throughout the 10-day period—even bypassing it on the seventh and eighth day. The MS method achieved an AUC of 92.71% on the tenth day (a 27% improvement), while the MMS method obtained an AUC of 91.62% on the tenth day (a 25.9% improvement from day zero). In addition, it can be seen that for the LR classifier, both the Random and MR methods yielded improvements in the detection performance, with a 24.4% AUC improvement for the Random method and a 19.02% AUC improvement for the MR method. For the TPF classifier, the MMS method improved the model's performance by around 11% and reached an AUC of 90.89% on the tenth day, and the MS method obtained an AUC of 89.84%. This is compared to the 90.53% AUC of the ALL scenario, the 85.29% AUC of the MR method and the lowest AUC of 83.4% obtained by the Random method, on the tenth day. In addition, the FPR graph of the TPF classifier shows that the use of the MS and MMS methods resulted in a significant improvement in the classifier's capabilities compared to the MR and Random methods, with a clear decline in FPR values over time. However, the RF classifier highlighted the superiority of the MMS and MS methods for the entire 10-day period over the ALL scenario and the other baseline methods, as can be seen in FIG. 7. Using the RF, the MMS and MS methods reached an AUC of 86.20% (16.85% improvement from day zero) and 84.81% (15.47% improvement from day zero) on the tenth day respectively (while on the tenth day, the AUC of the other methods was as follows: MR—78.81%, Random—79.34%). In addition to the results presented in FIG. 7, the detection capabilities of the best performing classifier (SVM in this case) on all of the malicious files that were not part of the 10-day period experiment were also evaluated. The evaluation was performed using the final model obtained after the tenth day update. Here, the effect of the selection methods on the relative improvement of the detection model compared to the hypothetic ALL scenario was examined. The results showed that the MS method achieved the highest relative improvement of 19% in the TPR compared to the ALL scenario. Not far behind was the MMS method which achieved a relative improvement of 15.5% in the TPR compared to the ALL scenario. In contrast, the Random and the MR methods showed a decrease in the TPR of 5.1% and 28%.

### 3) Exploring Daily Acquisition Amounts

In the previous two experiments, the ability of the methods presented herein to prioritize the acquisition of malicious samples and improve the models' detection performance over time for a fixed daily acquisition amount (K) of 100 samples was evaluated. In this experiment, however, the effect of different K values on the ability of the herein presented selection methods to improve the detection capabilities of the different models was examined. The daily amount acquired will vary from organization to organization based mainly on the availability of the required human resources (experts to perform the manual labeling). Thus, it is important to examine the different sampling methods and their impact on model performance for different daily acquisition amounts. The experimental configuration used in previous experiment was applied here, where different K values were used for daily acquisition. The K values examined are 50, 75, 100, 125, and 150. Since the focus of this experiment is on the different K values and their interaction with the different selection methods, in FIG. 7 which schematically shows the graphs of the results, the mean of the results of all four classifiers on the tenth day of the 10-day period is used. By doing so, drawing conclusions for each model individually is effectively avoided which increases the generalization of the experiment. F each K value tested, the selection methods yield better detection results than those of the Random and MR baselines and approach the ALL-hypothetical scenario's results.

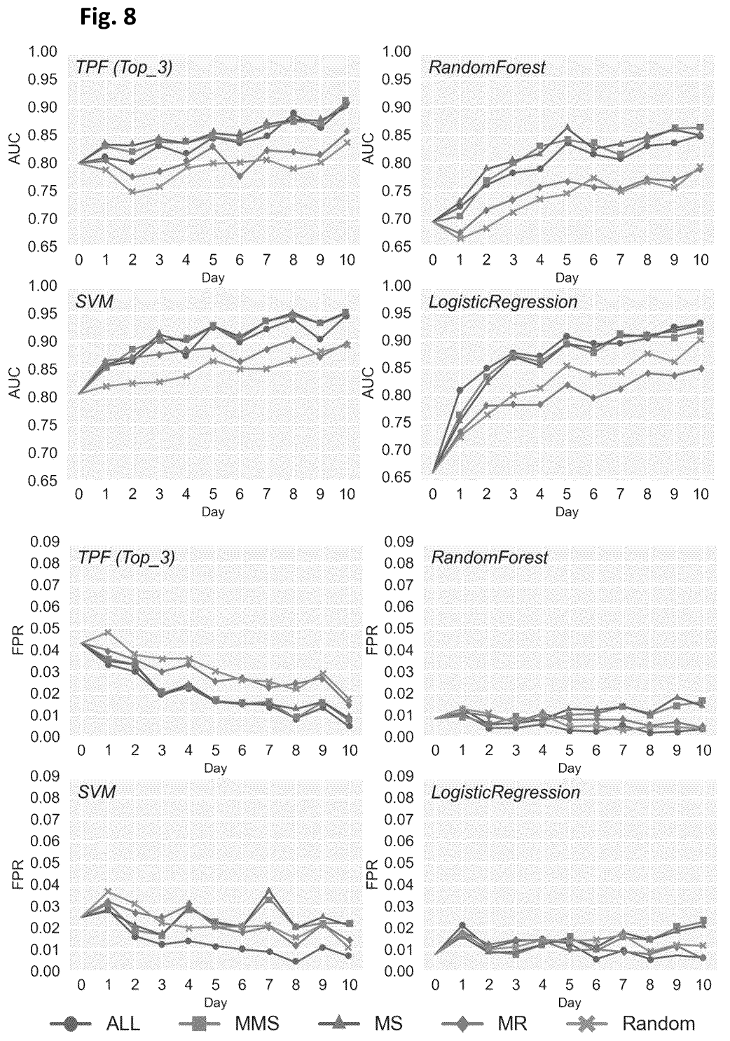

Here, the effect of the daily acquisition amount on the ability of the various selection methods to improve the performance of the detection models over the 10-day period was examined. FIG. 8 schematically shows the average performance of the four classifiers on the last day (after the model has been updated for 10 days) using different daily acquisition amounts (K), according to some embodiments.

First, for all the K values tested, the MS and MMS methods outperformed the Random and MR methods. In addition, as the daily acquisition amount increased, the gap between both the MS and MMS methods and the ALL scenario decreased to such an extent that starting from K values over 100, either the MS or MMS methods outperformed the ALL scenario, on average, across the four classifiers. Since the ALL scenario does not depend on K, its AUC value remains constant at 90.74% and serves as a measure to compare the herein presented methods to. For the daily acquisition of 50 samples, both the MS and MMS methods obtained an average AUC of about 87% with a standard deviation of 3.9% across the four classifiers, while the MR and Random methods respectively obtained an AUC of 84.13% and 81.45%. When the K value is raised to 75, the MMS and MS methods narrowed the gap toward the AUC of ALL, with an average AUC value of 90.19% for MS and 89.4% for MMS with a standard deviation of 2.8% and 3.2% respectively. Surprisingly, there is a decrease in the AUC value of the MR method which dropped to 83.53%, a value slightly lower than that of the Random method which achieved an AUC of 83.77% when K=75. When the daily acquisition amount was increased to 100, for the first time it was observed the phenomenon that at least one of the herein presented methods of the present disclosure managed to outperform the ALL scenario. It can be seen that the MMS achieved an AUC of 90.96% and the MS achieved an AUC of 90.58%, while the Random and MR methods respectively only obtained AUC values of 85.53% and 84.59%. When the K value is raised to 125 and 150, in addition to the fact that the MS method outperformed the MMS and ALL methods, there is no significant improvement in the average AUC values of all the methods. In the transition from 125 to 150, the AUC varied from 91.69% to 91.33% for the MS method, there was an increase from 90.34% to 90.87% for the MMS method, an increase from 86.53% to 87.36% for the Random method, and again surprisingly, a small decrease in the AUC from 85.42% to 84.08% for the MR method.

### 4) Identifying New Emerging Malicious Trends

One of the significant advantages of working with time-interval TPs is their ability to provide some explainability. In particular, when dealing with malware, TPs can capture real-life behaviors that represent malicious actions that in some cases would not arouse the suspicion of a human expert. In the case of AL, by which the new informative samples used to enrich the training set was acquire, it is natural to wonder whether it is possible to identify new behavioral trends in the data given the daily acquisition of new samples. In this case, the behaviors are actually the time-interval TPs, and the trends are the increases or decreases in their VS values among the classes in the training set over the 10-day period. Since it is interested in identifying malicious behavior trends, TPs for which there was a significant increase in VS values among the malicious class are looked for. In addition, since a VS threshold that determines which TPs will be considered frequent and serve as features for the detection model was used, it is most interested in TPs that were not defined as frequent at the beginning of the 10-day period but eventually crossed the VS threshold and have an increasing level of maliciousness, in terms of the VS difference between the classes. In this experiment, a daily acquisition amount of 100 samples was used (for the same reasons described above in experiment 1) and the MS selection method, as it is aimed at acquiring malicious samples, and therefore malicious trends are more likely to be found.

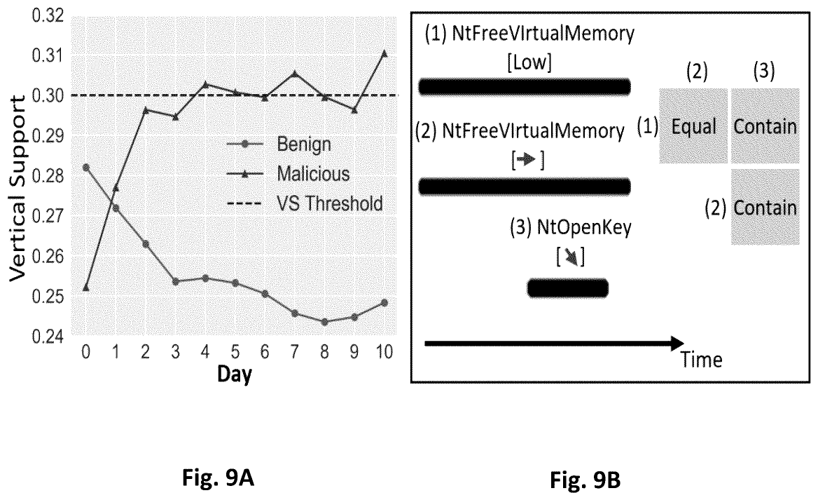

In this experiment, it was examined whether the time-interval TPs and the change in the VS that stems from the daily acquisition of new informative samples can be leveraged to identify new and important malicious behavior trends in the data. FIGS. 9A-9B schematically present an example of a malicious trend that was found (out of many that exist) when using the MS selection method over the 10-day period, according to some embodiments. FIG. 9A schematically shows the TP, that provides a clear human explainability regarding sample's behavior, that is also used to form detection prediction, and from which it can be learned about the API calls it contains, the TA performed, and the temporal relationships between all the intervals in the pattern. The TP contains two intervals of equal duration of the NtFree VirtualMemory API (which releases or decommits a region of pages for a specified process) and a third interval of the NtOpenKey API (which opens an existing registry key) whose duration is contained in both. One interval of the NtFree VirtualMemory API was abstracted with low State abstraction and the other one with stable Gradient. The NtOpenKey interval was abstracted with decreasing Gradient. FIG. 9B schematically shows the VS values of the TP in each of the classes as observed during the 10-day period. In the initial stage, the benign VS of the TP was around 28%, while among the malicious class the VS was about 25%. That is, on day zero the TP was observed in more benign samples than malicious samples. It was not considered frequent, since in none of the classes did its VS value cross the 30% threshold. Looking at the next four days, one can see an increase in the malicious VS of the TP to the level that the TP crosses the 30% threshold and is considered frequent. On the other hand, the benign VS of the TP decreases to about 25.3%. These two opposite phenomena seen in the VS values of the TP reinforce the fact that this is indeed a trend of new behavior that is more likely to be malicious. Over the next six days, the benign VS values of the TP continue to decline, and on the tenth day a value of 24.9% is obtained. On the other hand, the malicious VS values moves around the 30% line, and on the tenth day the value obtained is 31%. The TP mining process in this experiment revealed a total of 27,450 TPs. Of these, the number considered frequent varied depending on the selection method and daily acquisition amount used: 6,315 were considered frequent on day zero, and 2,069 were considered frequent on day 10. Overall, around 490 malicious trends were detected, 198 of crossed the 30% threshold using the malicious VS during the 10-day period, and 60 of them also showed a consistent decrease in the benign VS in parallel with an increase in the malicious VS values.

5) Comparing the Herein disclosed AL Framework to Traditional ML-based Detection Methods

This experiment compares the detector updated by the herein disclosed AL methods with traditional ML-based classifiers that do not use AL, to emphasize the need for such an AL-based process. Based on the experiments performed up to this point, the model that achieved the best detection results was selected and its performance over the 10 days of the experiment was compared to three ML classifiers that were updated using the herein disclosed AL framework. All models were trained on using same TPs based dataset and evaluate them on the next daily stream each day. While the AL model will make a daily acquisition of 100 samples and update itself each day, the traditional ML-based models are not updated by any new daily acquisitions. The AL-based model of the present disclosure will be compared to the same classifiers used in the previous experiments (Random Forest, SVM, and Logistic Regression) to highlight the effectiveness of using the herein presented AL framework. As in the previous experiments, a cross-validation setup was used.

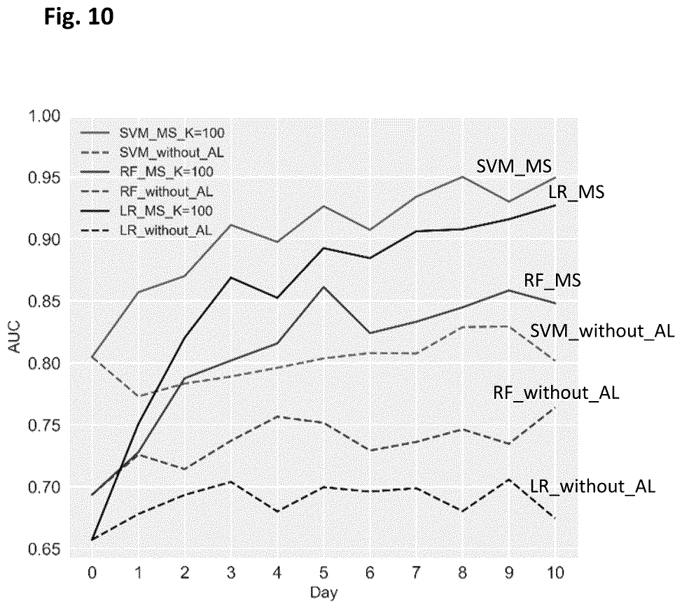

The results show that the SVM classifier with AL selection methods achieved the best detection results in each of the experiment's 10 days. Therefore, this model was chosen for the comparison with the non-AL-based traditional models, along with two additional classifiers (RF and LR), which had the second-best results. In addition, since the results achieved by the MS and MMS AL methods were almost the same in this experiment, in FIG. 9, only MS AL method was depicted. As can be seen in the figure, while the three detection models (SVM, LR, RF) that were updated daily using the herein disclosed AL method showed a consistent improvement, the traditional ML classifiers that were not updated and were not sustained with new informative samples using the AL framework showed no improvement in the AUC values over time. The difference in the generalization capabilities between the classifiers with and without the AL methods presented herein ranged from 8% (for RF) to 26% (for LR) on the tenth day. FIG. 10 schematically shows MS-based ML classifier of the present disclosure compared to three traditional ML classifiers, according to some embodiments. As can be seen, on day zero, both the AL-based detection models (solid lines) and the traditional detection model (dashed lines) have the same AUC values, as the models were trained on the initial training set and had not yet been updated. Over the course of the 10 days of the experiment, the detection capabilities of the AL-based models significantly improved. In contrast, the AUC values of the traditional detection models remained the same (excluding the RF which had slight improvement but still performed more poorly than its AL-based version).

1.-27. (canceled)

28. A method for detecting unknown portable executable (PE) malware, comprising the steps of:
receiving a new stream of PE files with unknown label of malicious or benign;
executing the unknown label PE files in a dynamic analysis environment;
creating application programming interface (API) call multi variate time series data (MTSD);
extracting time-interval temporal patterns (TPs) representing the PE files from said API calls MTSD;
applying on the PE files represented by the TPs a machine learning (ML) based detection model and an AL module;
receiving ML predictions labels based on TPs from the ML based detection model;
selecting a subset of PE files by the AL module;
labeling each PE file based on the dynamic analysis and identified TPs and on the ML predictions labels;
detecting malicious PE files based on the labeled subset of PE files by the AL module and/or the received ML predictions labels.

29. The method of claim 28, wherein the API calls MTSD are created by extracting API names and timestamps and arranging the API names and timestamps in a raw table.

30. The method of claim 29, wherein extracting time-interval TPs comprises dividing each sample's raw MTSD into sized bins, and calculating occurrence rates of the API calls that appear in each bin.

31. The method of claim 30, wherein the bins have equal time length.

32. The method of claim 31, wherein each bin size is in the length of about 0.5-3 seconds.

33. The method of claim 28, further comprising a step of comparing the received stream of PE files with unknown label to files in an antimalware repository and filtering only the PE files with unknown label.

34. The method of claim 33, comprising utilizing a selection method for selecting a subset of PE files, said selection method assigns a vertical support (VS) score for each file.

35. The method of claim 34, wherein the selected subset of PE files comprises PE files that have been identified to be the most informative PE files in accordance with the utilized selection method; wherein the most informative PE files are the files with the most frequent TPs.

36. The method of claim 34, wherein the selection method is selected from: Random, All, Marginal Ratio (MR), Malicious Score (MS) and Marginal Malicious Score (MMS).

37. The method of claim 34, further comprising a step of adding the labeled PE files to a training set of the ML based detection model and updating the ML based detection model and/or the VS scores of the TPs based on the labeled PE files.

38. The method of claim 34, wherein the vertical support score is the maximum frequency of a specific TP among all of the TPs belonging to a specific class.

39. The method of claim 28, wherein the dynamic analysis and temporal patterns based active learning (AL) framework, are performed on host and guest environments and a sandbox tool which integrates between the host and guest environments.

40. The method of claim 28, comprising selecting a ML classifier and applying on the PE files represented by the TPs the ML based detection model using said selected ML classifier.

41. The method of claim 28, wherein applying on the PE files represented by the TPs the ML based detection model and the AL module is performed simultaneously.

42. The method claim 28, further comprising providing an explanation regarding the prediction label and/or the detection of the malicious files, wherein the explanation is based, at least in part on a trend of TPs of a PE file.

43. A method for selecting a subset of PE files represented by time interval temporal patterns (TPs) having a vertical support (VS) value for each TP, in an active learning module, comprising:
receiving a plurality of PE files;
calculating for each PE file a maliciousness value of each TP by an exponent to the power of a difference between the TP's VS values for a malicious class and a benign class; and
selecting the PE files with the maliciousness value which are above a predefine threshold.

44. The method of claim 43, wherein the maliciousness value is calculated according to equation (3):
$$M S ( {s}_{i} ) = \frac{1}{N} {\sum }_{j = 1}^{N} {e}^{( {VS}_{M , j} - {VS}_{B , j} )} \qquad ( 3 )$$
wherein MS (sᵢ) denotes the malicious score of a PE file sᵢ;
N denotes the number of TPs identified in the PE file;
VS_{M,j} denotes the VS value of the j'th TP for the malicious class; and
VS_{B,j} denotes the VS value of the j'th TP for the benign class.

45. The method according to claim 44, further comprising:
calculating a marginal ratio score MR (sᵢ) for the PE file according to equation 2:
$$M R ( {s}_{i} ) = \frac{1}{N} {Σ}_{j = 1}^{N} {1}_{LB < max \{ {VS}_{M , j} , {VS}_{B , j} \} < U B} \qquad ( 2 )$$
wherein LB denotes a lower bound of the margin and UB denotes an upper bound of the margin;
and calculating a marginal malicious score MMS (sᵢ) for the PE file according to equation (4):
$$M M S ( {s}_{i} ) = ( 1 - β ) * M R ( {s}_{i} ) + β * M S ( {s}_{i} ) \qquad ( 4 )$$
Wherein β is a coefficient that determines the weight of each method MR (sᵢ) and MS (sᵢ) in the final MMS (sᵢ) score.

46. A non-transitory computer-readable medium having stored thereon instructions that cause a processor to:
receive a new stream of PE files with unknown label of malicious or benign;
execute the unknown label PE files in a dynamic analysis environment;
create application programming interface (API) call multi variate time series data (MTSD);
extract time-interval temporal patterns (TPs) representing the PE files from said API calls MTSD;
apply on the PE files represented by the TPs a machine learning (ML) based detection model and an AL module;
receive ML predictions labels based on TPs from the ML based detection model;
select a subset of PE files by the AL module;
label each PE file based on the dynamic analysis and identified TPs and on the ML predictions labels;
detect malicious PE files based on the labeled subset of PE files by the AL module and/or the received ML predictions labels.

47. A system for detecting unknown portable executable (PE) malware, comprising:
a processor executing a code configured to execute the method according to claim 28.
